(19) United States
(12) Patent Application Publication
(10) Pub. No.: US 2014/0143131 A1
(43) Pub. Date: May 22, 2014

(54) VERSATILE SYSTEM FOR MORTGAGE PROCESSING

(71) Applicant: Louis Lee Michael Baca, Murphy, TX (US)

(72) Inventor: Louis Lee Michael Baca, Murphy, TX (US)

(21) Appl. No.: 14/070,482

(22) Filed: Nov. 1, 2013

Related U.S. Application Data
(60) Provisional application No. 61/721,357, filed on Nov. 1, 2012.
(60) Provisional application No. 61/805,944, filed on Mar. 28, 2013.

(51) Int. Cl. G06Q 40/02

(52) U.S. Cl. CPC G06Q 40/025
USPC 705/38

(57) ABSTRACT

A versatile, automated system for processing mortgages in a convenient, easy and economical manner. The system of the present disclosure provides an operational kernel that consolidates all aspects of applying for, processing, underwriting, and approving a mortgage. The system provides various structures, engines and methods for consolidating all aspects of mortgage application, handling, administration and approval processes within a unified operational environment.

### PRIORITY CLAIM

This application claims priority of U.S. Provisional Application No. 61/721,357, filed Nov. 1, 2012 and U.S. Provisional Application No. 61/805,944, filed Mar. 28, 2013.

### TECHNICAL FIELD OF THE INVENTION

The present disclosure relates generally to the field of mortgage processing and, more particularly, to structures and methods for consolidating all aspects of mortgage application, administration and approval processes within a unified operational environment.

A variety of products and services are available for addressing various aspects of the mortgage application and approval process. Conventionally, the mortgage process is extremely labor- and information-intensive. Lenders, especially those lending relatively large amounts of money, want a considerable amount of information to assist them in evaluating a potential borrower for risk and/or return potential. When this is coupled with numerous state and federal legal and regulatory requirements, each mortgage application compiles a sizable volume of data and documentation. This large volume of data is then analyzed and evaluated by and through numerous quantitative and qualitative functions. Typically, conventional mortgage processes perform many, if not most, of the collection and evaluation of this data and documentation on a manual basis.

### SUMMARY OF THE INVENTION

The present disclosure provides a versatile, automated system for processing mortgages in a convenient, easy and economical manner. The system of the present disclosure provides an operational kernel that consolidates all aspects of applying for, processing, underwriting, and approving a mortgage.

Specifically, the system of the present disclosure provides a loan processing system. That system comprises structure adapted to acquire applicant goals, and to acquire loan offers. The system comprises structure adapted to compare loan offers to applicant goals, and to identify one or more loan offers for presentation to the applicant. The system comprises structure adapted to present the identified loan offers to the applicant, and to acquire an identification of a preferred loan offer.

More specifically, the system of the present disclosure provides a mortgage processing system, having structures adapted to acquire applicant goals and to acquire mortgage offers. The system has structure adapted to compare mortgage offers to applicant goals, and adapted to identify one or more mortgage offers for presentation to the applicant. The system has structure adapted to present the identified mortgage offers to the applicant, and to acquire an identification of a preferred mortgage offer.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a schematic of a network wherein the teachings of the present disclosure may be employed;

FIG. 2 is a schematic showing certain key operational elements of the present disclosure and their relationships to one another;

FIG. 3 is a flowchart showing one embodiment of the loan application process of the present disclosure;

FIG. 4 is a schematic showing certain operational engines of the present disclosure and their connections to the central database and to one another;

FIG. 5 is a block diagram showing certain aspects of the application engine;

FIG. 6 is a block diagram showing certain aspects of a research engine;

FIG. 7 is a block diagram showing certain aspects of a regulatory engine;

FIG. 8 is a block diagram showing certain aspects of a compilation engine;

FIG. 9 is a block diagram showing certain aspects of an underwriting engine;

FIG. 10 is a block diagram showing certain aspects of a title engine;

FIG. 11 is a block diagram showing certain aspects of a closing engine;

FIG. 12 is a block diagram showing certain aspects of a notifications engine;

FIG. 13 is a block diagram showing certain aspects of an administration engine;

FIG. 14 is a block diagram showing certain aspects of a processing engine;

FIG. 15 is a screen layout of an interface for an initiation engine;

FIG. 16 is a screen layout of a goals interface;

FIG. 17 is a screen layout of a preliminary application interface;

FIG. 18 is a flowchart showing a process flow for loan filtering;

FIG. 19 is a screen layout of a loan comparison interface;

FIG. 20 is a screen layout of an account creation interface;

FIG. 21 is a screen layout of a full application interface;

FIG. 22 is a flowchart showing a process of applicant screening;

FIG. 23 is a screen layout of a credit pull interface;

FIG. 24 is a screen layout of z disclosures interface;

FIG. 25 is a screen layout of an employment verification interface;

FIG. 26 is a screen layout of an asset verification interface;

FIG. 27 is a screen layout of a title company selection interface;

FIG. 28 is a screen layout of an appraisal interface;

FIG. 29 is a screen layout of a validation interface;

FIG. 30 is a screen layout of an adjustments interface; and

FIG. 31 is a screen layout of an underwriting interface.

### DETAILED DESCRIPTION OF THE DISCLOSURE

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of processing a mortgage application. The specific embodiments discussed herein are, however, merely illustrative of specific ways to make and use the disclosure and do not limit the scope of the disclosure.

A mortgage processing system of the present disclosure provides structures, engines and methods for consolidating all aspects of mortgage application, handling, administration and approval processes within a unified operational environment. The system of the present disclosure provides an operational kernel that consolidates and automates all aspects of these processes, while providing a user with monitoring, editing and override capabilities. A number of operational constructs are provided within the overarching main operation kernel that are able to responsively interact with one another, and may further receive data from, and output data to, external manual and automated resources via engines, portals, modules or other similar constructs. Simple and intuitive user interfaces are provided to assist in simplifying the overall process.

More specifically, the system of the present disclosure provides structures, engines and methods for mortgage application, handling, underwriting and approval processes, consolidated within a unified operational environment regardless of systems used by numerous data input resources and data output demands.

A number of operational engines are provided to perform various data gathering, data entry, data output and/or data processing functions. These engines may be provided as independent structures, as segments of a larger structure, or as varied combinations of both. All such engines may communicate and/or interoperate with other engines, and the addition, update or development of data in one engine may be responsively updated in or used by other engines. All such engines may have a variety of manual and/or automated inputs or outputs.

The various functional engines depicted and described herein may be constructed and implemented via a wide variety of structures, apparatuses and methods known to those of skill in the art. In certain embodiments, the engines may be implemented on an array of separate task-specific processing units, computers or servers. The engines may be implemented as software programs or routines running on a single processing unit, computer or server. The engines may be implemented within a server “cloud,” wherein various computers or processors may conduct various tasks at varying times, depending on system load and available resources. Any one or more of such engines may be structured as sub-segments of another engine, may share specific functionalities with one or more other engines or may have their functions divided in a different manner than the manner depicted and described herein. All of these are within the skill of one of skill in the art to which the present disclosure pertains.

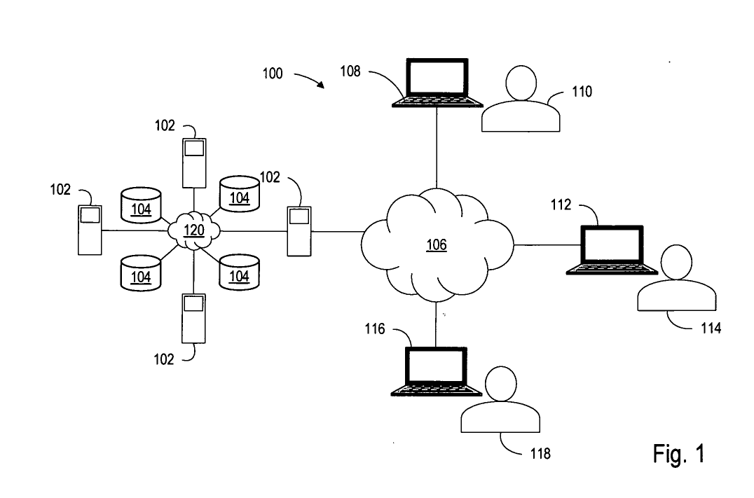

FIG. 1 is a schematic of a generalized network environment 100 wherein the teachings of the present disclosure may be employed. As seen in FIG. 1, an array of operational engines operate on one or more servers 102, each having access to one or more databases 104. At least one of servers 102 may be connected to an external network 106, which may provide a connection to external resources and nodes. An array of users 110, 114, 118 are able to access the information and tools on servers 102 and databases 104 via client machines 108, 112, 116 operably connected to the network 106 via an internal network 120.

Although client machines 108, 112, 116 are depicted as being laptop or netbook type computers, those of skill in the art will appreciate that the network 106 may be accessed by desktop machines, tablets, smartphones, rack-mounted units or other types of equipment. These devices may operate on any one or more of a variety of operating systems, including Microsoft Windows, Apple MAC OS, Apple iOS, Android, Linux or Blackberry OS, as examples. Any of the client machines 108, 112, 116 may connect to network 106 via an Ethernet connection, an ADSL connection, cable internet, dial-up, 802.11 (Wi-Fi,) a cellular data connection or any combination of the above. In certain embodiments, the client user interface is designed to be implemented within a browser window, but may also be implemented as a stand-alone application running on any of the aforementioned operating systems and devices.

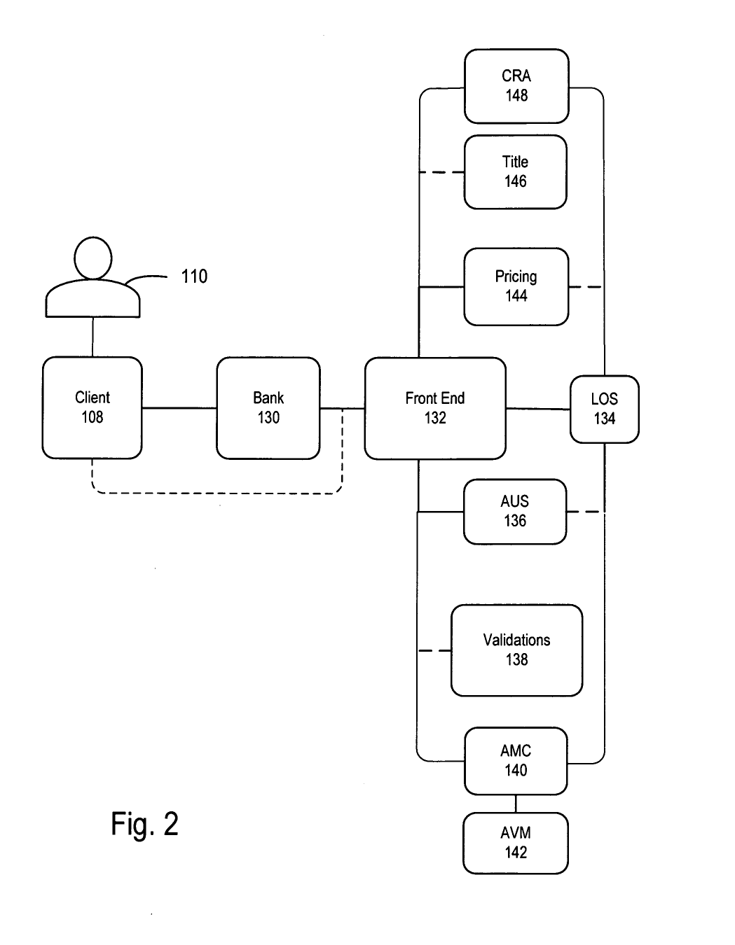

FIG. 2 is a schematic showing certain key operational elements of the present disclosure and their relationships to one another. As seen in FIG. 2, a borrower 110 at client machine 108 may access Front End 132 either via Bank Website 130, or more directly, without going through Bank Website 130. Depending on the manner in which Front End 132 is accessed, the experience of borrower 110 may be different.

Front End 132 serves as an operational portal to the various engines and related components running on servers 102, certain of which are shown in FIG. 2. The engines and related components include Loan Origination System (LOS) Engine 134, Automated Underwriting System (AUS) Engine 136, Validations Engine 138, Appraisal Management Company (AMC) Engine 140, Automated Valuation model (AVM) Engine 142, Pricing Engine 144, Title Engine 146 and Credit Reporting Agency (CRA) Engine 148. The function and characteristics of these modules and portals is described in detail below.

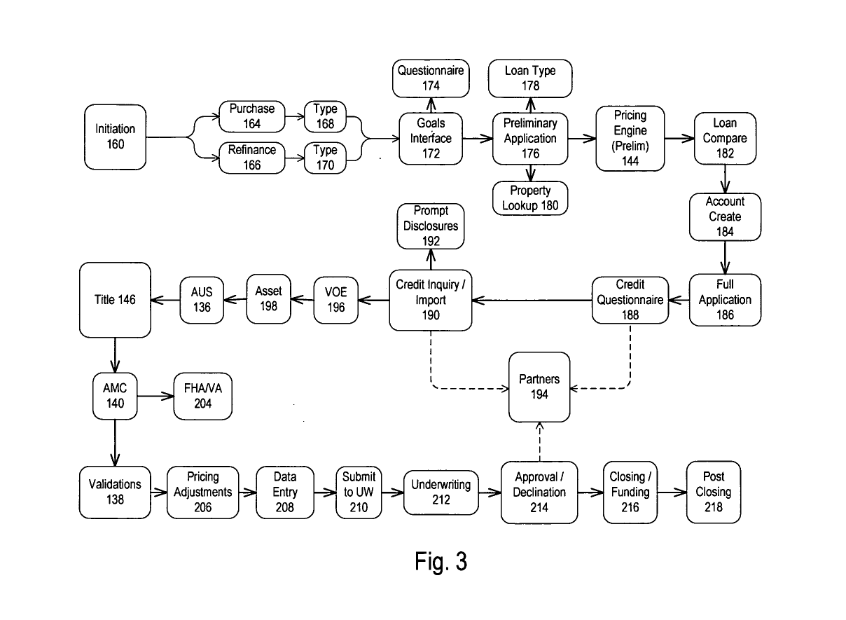

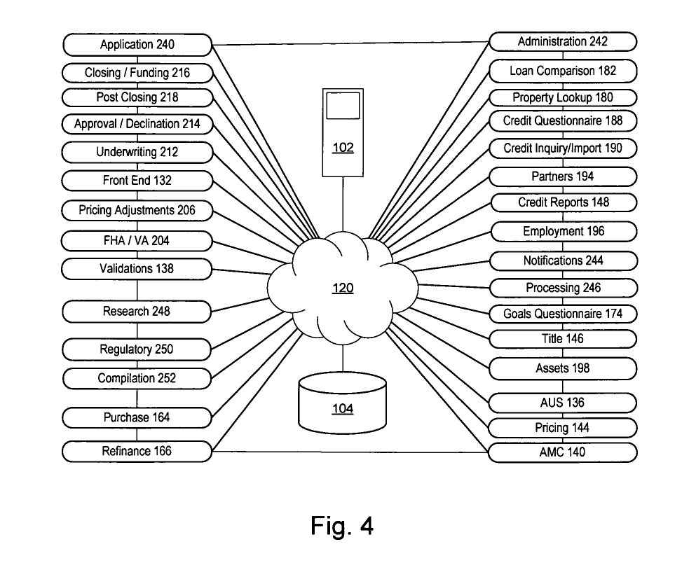

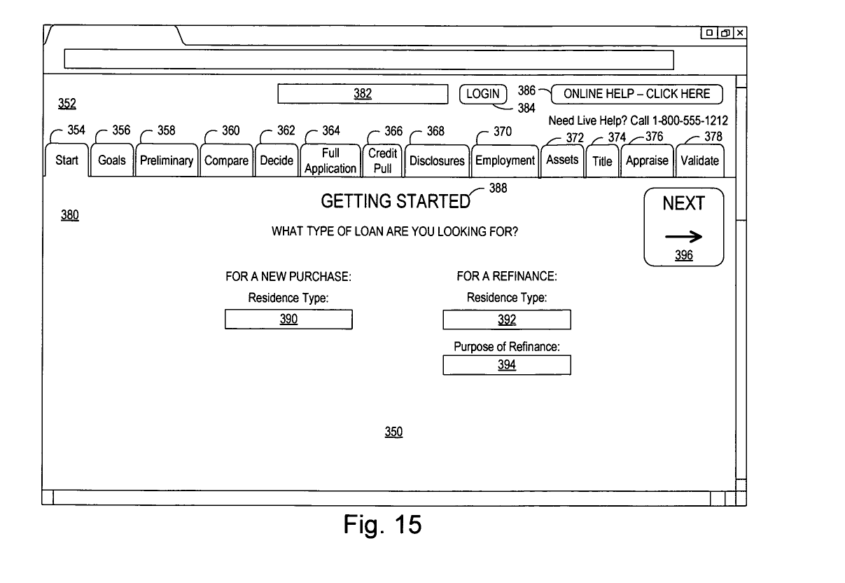

Referring now to FIGS. 3 and 4, the present disclosure is described in reference to one general embodiment of unified mortgage processing system according to the present disclosure. As seen in FIG. 3, process flow begins with an Initiation Engine 160. A screen view of one embodiment of an initiation engine interface is shown in FIG. 15 and described in detail below. On this page, a user will be prompted for, and will make, selections according to the overall purpose of the loan—i.e., whether the applicant is seeking a mortgage for a new purchase (164) of a home or a mortgage refinance (166). If a loan for a new purchase is desired, the user will be prompted to indicate residence type, such as primary, secondary/vacation, investment property (168).

If refinance is desired, the user will be prompted to indicate the residence type (170). Additionally, a drop down prompt may be provided to inquire about the purpose of the refinance (cash-out, no cash-out rate and term). After the necessary information is entered, the user clicks the ‘Next’ button to proceed.

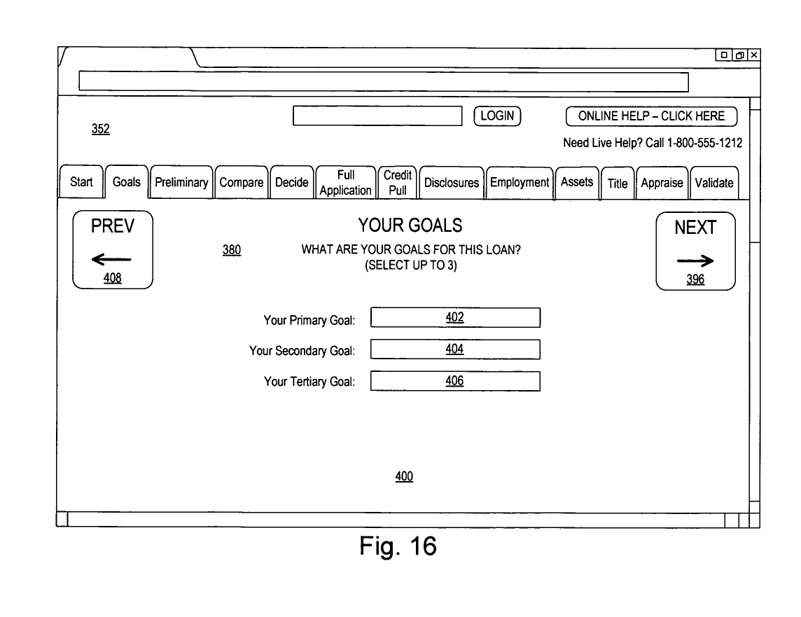

A Goals Interface Engine 172 presents a questionnaire to determine primary, secondary and possibly tertiary goals for the loan sought. A screen view of one embodiment of a Goals Interface is shown in FIG. 16 and described in detail below. As an example, a user may register an intention to live in the property for less than 5 years as a primary goal, with obtaining the lowest interest rate and building equity as lower priority goals. These three goals may then, in turn, provide a 15 year fixed rate mortgage, an Adjustable Rate Mortgage or a 10 year fixed rate mortgage as possible options. After the necessary information is entered by the user, the user clicks the ‘Next’ button to proceed to the next screen.

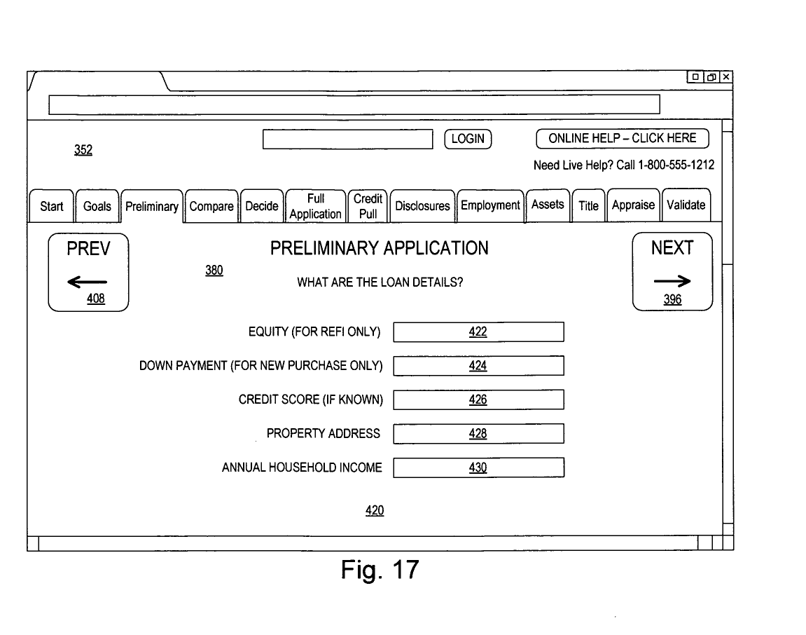

After the Goals Interface Engine 172 completes its work, control proceeds to the Preliminary Application Engine 176. One embodiment of this page is shown in FIG. 17 and described in detail below. This page may interface with the Application Engine 240, Loan Type Engine 178 and Property Lookup Engine 180. Information from this page can help determine additional important information, including approximate equity (if refinance) or down payment (if purchase), approximate credit profile, property lookup (for outside portals such as USDA search, AVM, FNMA/Freddie Mac, etc.) and income information. After the applicant enters the required information, the ‘Next’ button will move control to the next engine.

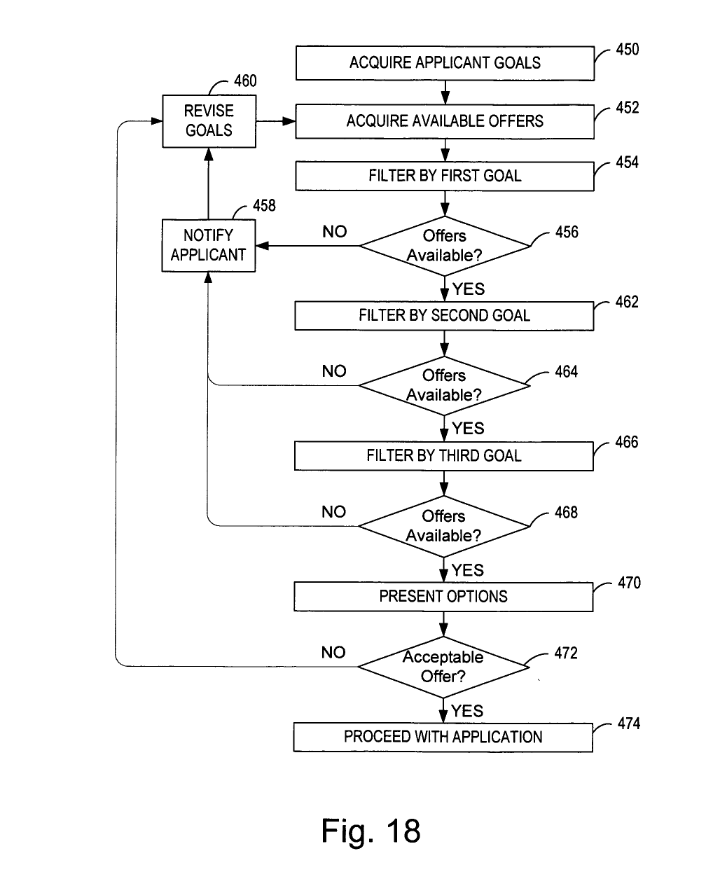

From Preliminary Application Engine 176, operation continues to Pricing Engine 144, which may tie into another back-end pricing engine operable to determine pricing adjustments and rate lists for multiple scenarios. The information acquired via the Preliminary Application Engine 176 will be fed into the process set forth in FIG. 18 and described in detail below. In certain embodiments, the user may see an equivalent of hourglass or some other graphic indicating processing of information while the Pricing Engine 144 is working.

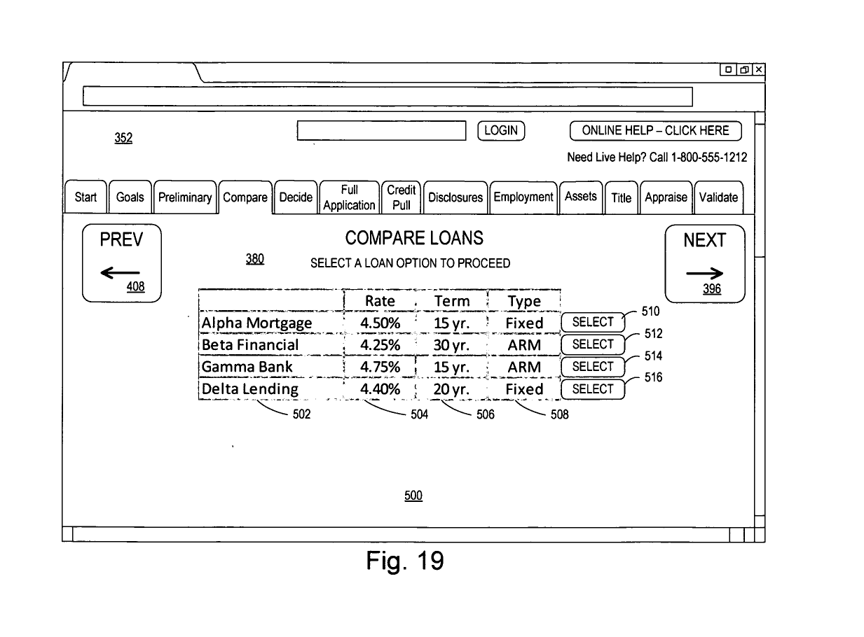

After the information is processed, it is presented via the Loan Comparison Engine 182, which populates eligible loan programs and terms based off of the information given in the preceding pages. FIG. 19 shows a screen layout of one interface for Loan Comparison Engine 182. The information presented may include indicate rate lists, approximate closing costs, terms, eligibility, reserve requirements, amortization calendars, highlights and downfalls. The user may receive an indication or highlight of which programs best fit their goals. To proceed, the user selects a particular loan offer and clicks ‘Next.’

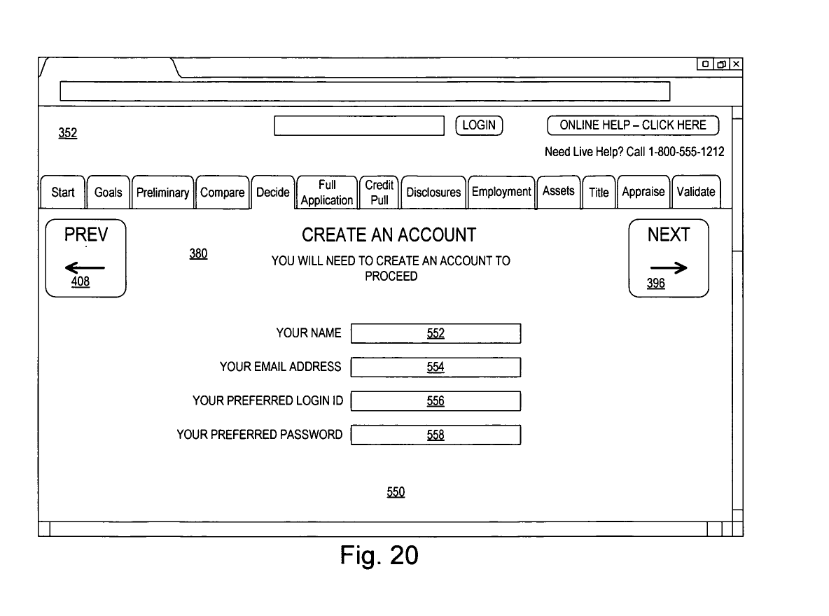

From Loan Comparison Engine 182, operation continues to an Account Creation Engine 184, which requires the user create an account in order to proceed. An embodiment of an Account Creation Engine interface page is shown in FIG. 20. By the time the user has reached the account creation interface, the user has chosen a loan program, and is thus prompted to create an account in order to securely: 1) input personal data; and 2) be able to save and come back later to finish. Depending upon the details of the system, some embodiments may provide a user with an opportunity to log in via their online bank account, which can then authenticate the user to the server.

After the user creates an account, operation continues to Full Application Engine 186, which is, technically speaking, the beginning of the actual loan process. In certain embodiments, a complete traditional application may be included into the site, but with features designed to facilitate a much more user friendly experience. The Full Application Engine 186 may be divided into several sub-components, and the interface may be separated in to several pages, so as to not overwhelm the user with too much data entry on one page.

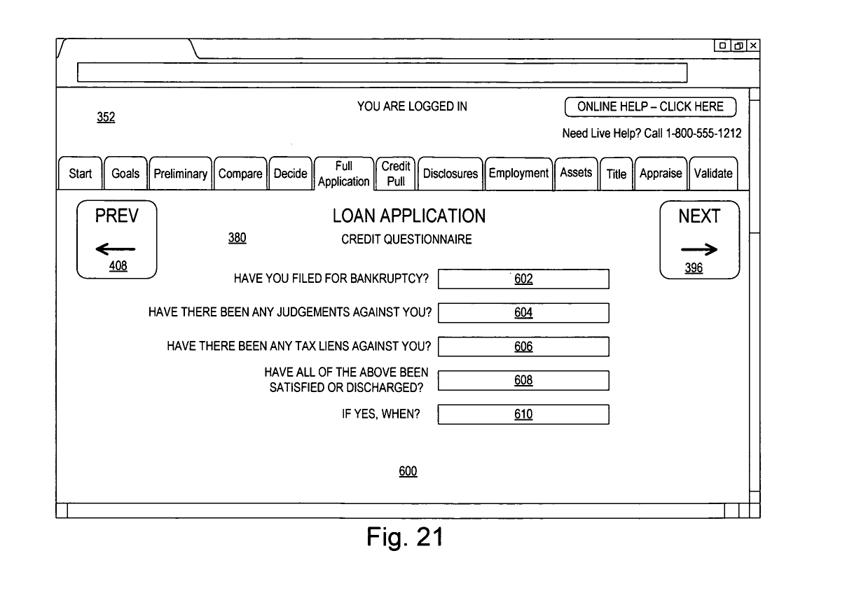

Via a portion of the interface for the Full Application Engine 186 or as a separate page, a Credit Questionnaire Engine 188 presents a credit questionnaire to the user. One embodiment of an interface for Credit Questionnaire Engine 188 is included below as FIG. 21. It should be noted that at every milestone from the Full Application Engine 186 onward, the information given on each page will be measured against: 1) the guidelines for that program; and 2) any adjustments from the Pricing Engine 144. This may occur each time the user pushes the ‘Next’ button to gain access to the next page. If there is a conflict with either the guidelines or Pricing Engine 144, there may be a stop or block imposed that prevents the user from continuing until the conflict is resolved. This stop or block may also activate if the information given conflicts with the same information given previously, or if the data entry is not complete in that section. Certain pages, or all of them, may include a ‘Frequently Asked Questions’ (FAQ) or ‘Help’ button regarding the information on that page.

Credit Questionnaire Engine 188 may provide a pop-up that prompts the user before allowing a credit pull. At this point the user may have already given permission in the application section to pull credit. Thus, Credit Questionnaire Engine 188 presents the user with an opportunity to indicate any items on their credit report that may significantly affect the eligibility of the user for the preferred loan program. This functionality may be provided to: 1) avoid any unnecessary costs associated with a credit inquiry for the bank; and 2) avoid any unnecessary inquiries for the user, as numerous inquiries are known to negatively affect credit scores. If the user elects not to proceed, control is transferred to Denial/Partner Portal 194.

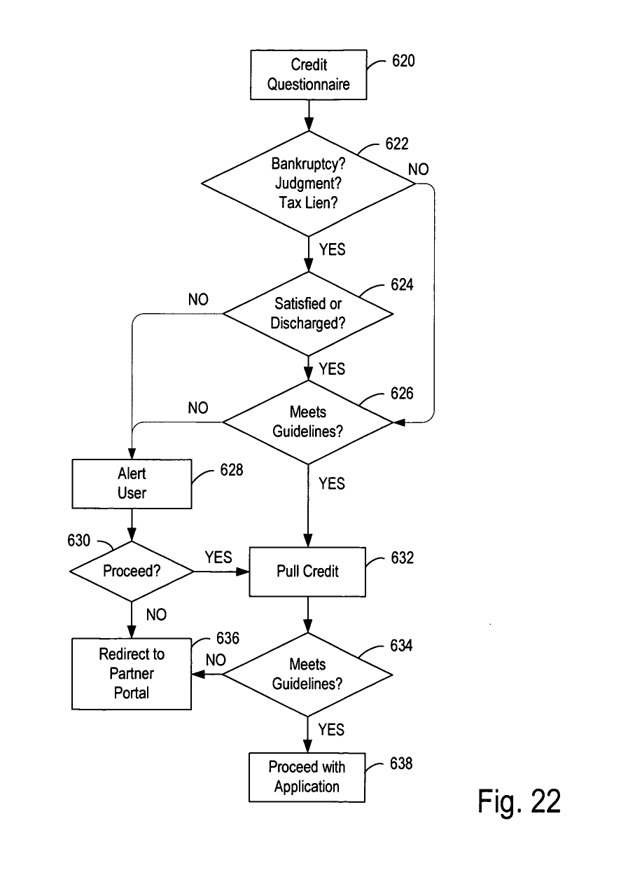

One embodiment of the above-described pre-screening process is set forth in FIG. 22 and described in detail below. One example of the questionnaire would prompt the user to indicate if they have had a negative indication on a public record, such as a bankruptcy, judgment, or tax lien and if so, when and if was it satisfied or discharged. If none of the questions apply to the user, the user may indicate that they do not apply or are not aware that of any such information. If the user's answer conflicts with the guidelines for the preferred loan package, an indicator may indicate that they do not currently qualify based on the guidelines, and indicate the statute of limitations in order to qualify. The user may still have the option to continue forward with the credit inquiry, but will be warned that the inquiry may affect their credit score. They may also choose to be redirected to a partner page/portal for education on credit and tools. If they do not have anything which conflicts with the guidelines, the application proceeds.

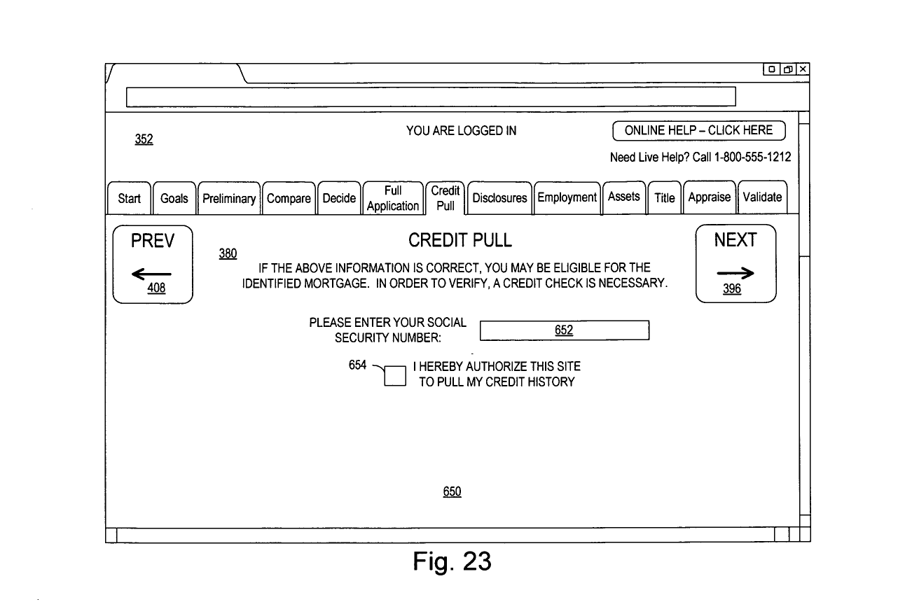

If the user elects to perform a credit pull, the user is presented with a query for their social security number and an authorization to pull a credit report via the Credit Inquiry/Import Engine 190. An embodiment of this page is included below as FIG. 23. Once the user enters their social security number and presses a button to pull their credit report, the system contacts the appropriate credit reporting agencies (CRAs) for information on the user's credit history. As the report populates, it may automatically import in the back end of the system without any further action or input from the user. In some embodiments, the Credit Inquiry/Import Engine 190 may provide opportunities for the user to add notes next to any account for explanation purposes, but does not allow them to edit any other portion of the information.

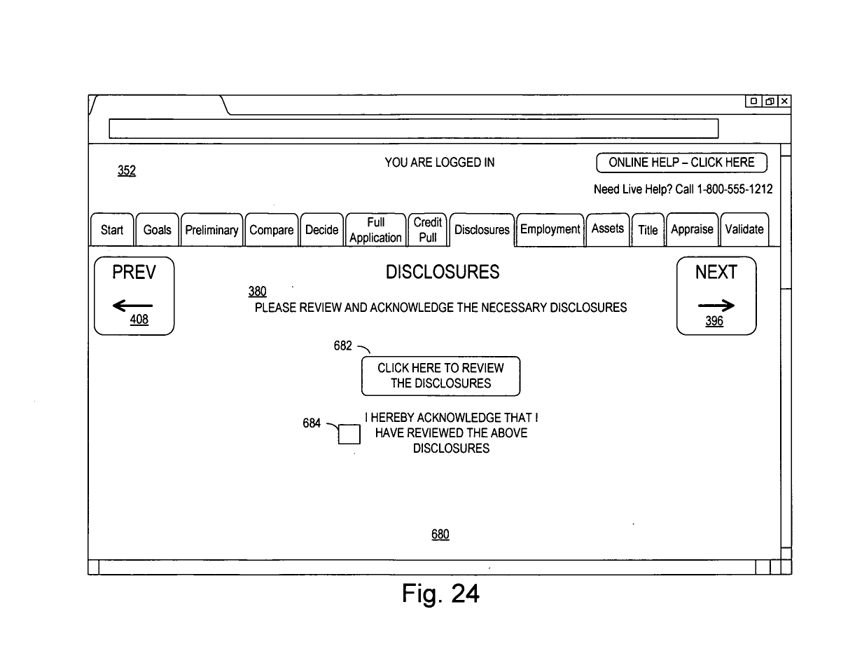

Operation continues to the Disclosures Engine 192. When a user provides their social security number, an indication may be given that this will be the sixth, and last, piece of information required before triggering disclosure obligations. One embodiment of a user interface for Disclosures Engine 192 is included as FIG. 24. These disclosures will be displayed and, similar to an online license or software terms and conditions, operation will not continue forward until all disclosures are accessed, viewed, clicked through and/or otherwise acknowledged. In some embodiments, video or visual tutorials may talk the user through each disclosure. If the credit report indicates that the applicant is not eligible for the loan, control may be transferred to Denial/Partner Portal 194.

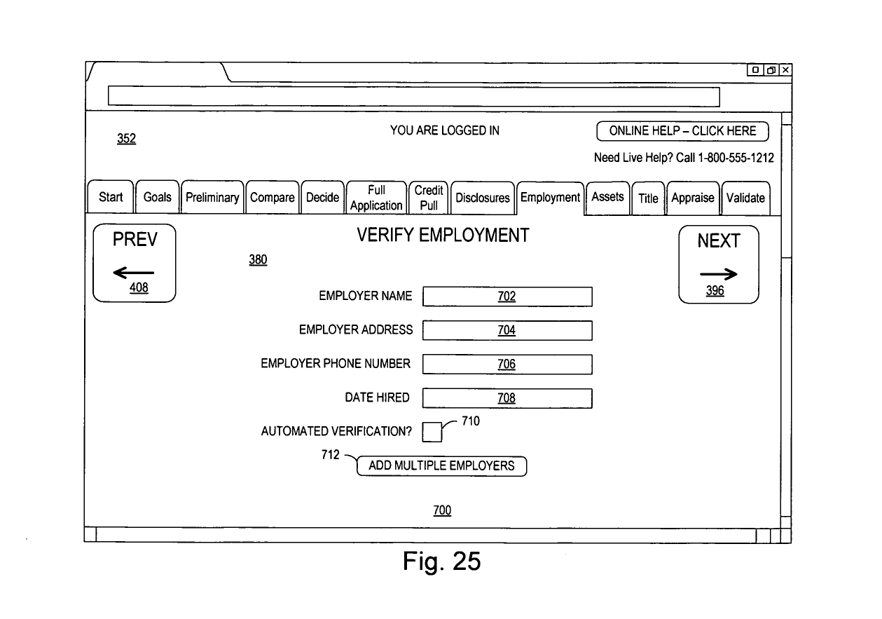

After disclosures, operation continues to Verification of Employment (VOE) Engine 196, which provides the user with the opportunity to enter information relating to his or her employer(s). One embodiment of an interface for VOE Engine 196 is included as FIG. 25. The user may be prompted for various types of information, including company address, phone number, and date hired. They may also select an automated VOE, if their employer is set up with one. They may have the option to input multiple employers. The VOE Engine 196 may then trigger a message to a loan coordinator at the bank, or some automated system, to order verification from the employer.

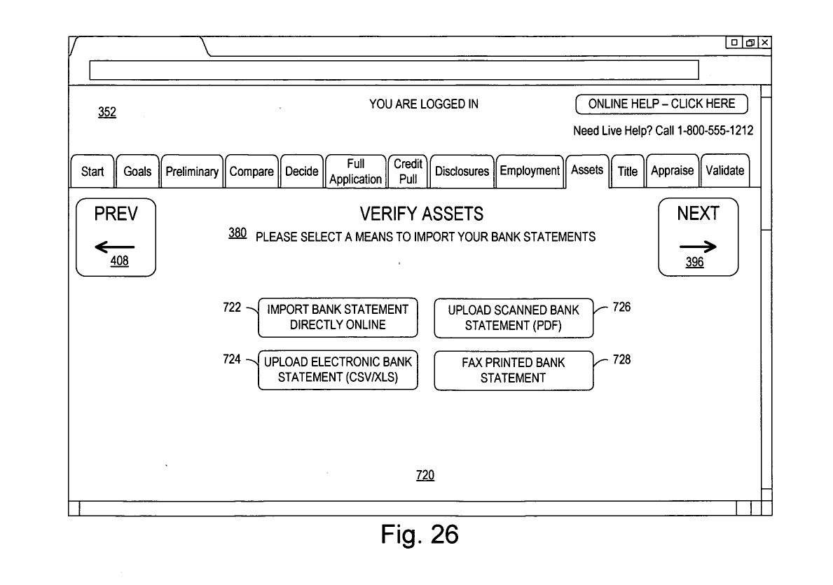

After employment verification, operation continues with asset verification via the Asset Engine 198, which may be provided in a variety of embodiments and using a variety of tools. FIG. 26 is a screen layout of an asset verification interface page for the Asset Engine 198. In certain embodiments, a user may import their bank statements directly over the web. This might be particularly feasible if their bank is the institution from which they are currently seeking a loan. Certain embodiments may provide a user with the ability to download, or import, their bank statements from their other banking institutions. Certain embodiments provide a user the ability to fax or scan such documents and upload them through a computer. Once the necessary bank statements are successfully imported, uploaded, scanned, faxed or otherwise provided to the system, the user may click ‘Next’ to move on to automated underwriting.

After asset verification, operation continues via an Automated Underwriting System (AUS) Engine 136 which analyzes the data provided by the user. AUS Engine 136 may provide a suitable communicative connection to enable the applicant to order underwriting. The resulting findings are then imported into the system. The findings may include, but are not necessarily limited to, a determination as to whether or not the user is preliminarily approved for the preferred loan. The type of finding that may prevent approval may include, for example, a determination that the applicant has insufficient funds to proceed with closing.

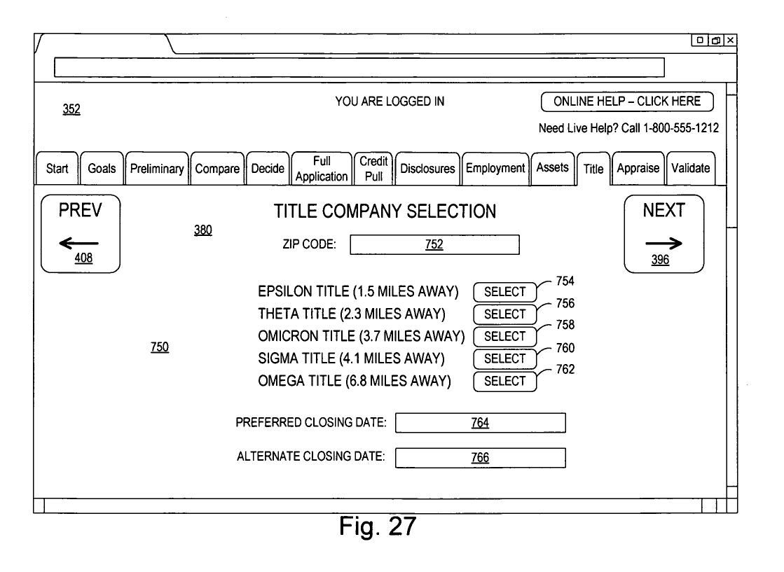

If automated underwriting indicates that the applicant is preliminarily approved for the loan, operation continues to Title Engine 146. One embodiment of a title company selection interface is included as FIG. 27. The title company selection interface allows a user or loan process representative to search for title companies that are geographically nearby. After a title company is selected, the user may provide additional data for arranging a closing, such as address, telephone number and preferred closing date and time. In some embodiments, entry of this data may then notify a Loan Coordinator at the bank, or some automated system, to order or arrange a closing appointment.

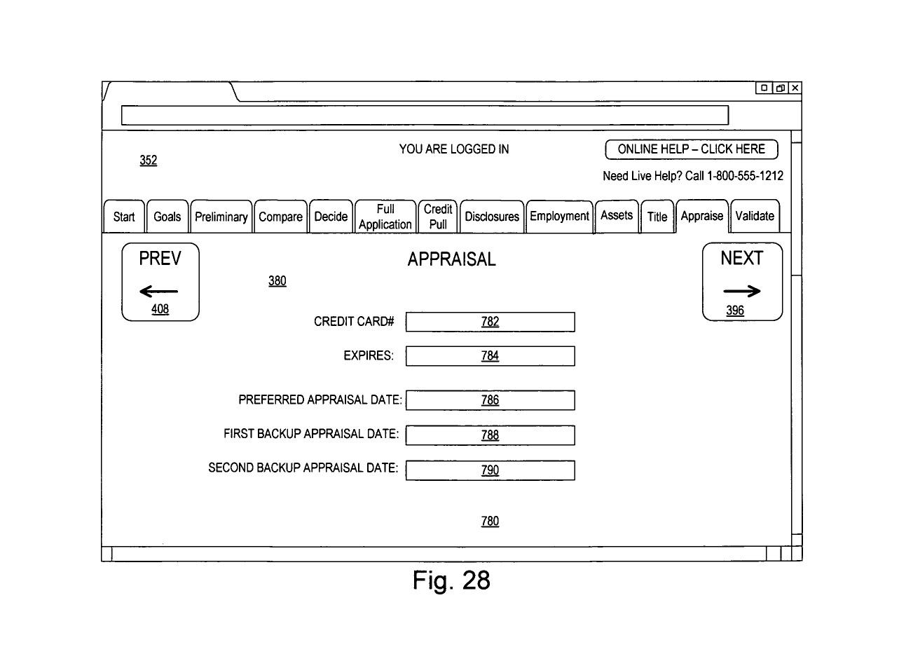

After a title company is successfully selected, operation continues to the appraisal process via Appraisal Management Company (AMC) Engine 140 working alone or in concert with FHA/VA Engine 204. FIG. 28 is a screen layout of one embodiment of an appraisal interface. According to certain embodiments, the appraisal interface may query for a user's credit card information if payment for the appraisal is required up front. In certain embodiments, the interface may enables a user to indicate up to three different dates and times for the appraiser to do the appraisal. In some embodiments, entry of such data may automatically generate an email or text message to the user, once the appraisal has been accepted by the appraisal management company. Similar notifications may be sent when the appointment is accepted by the appraiser, when a reminder for the appointment is due, and/or when the appraiser has submitted the appraisal to the bank. A similar notification process may be utilized as a mechanism to keep the user constantly and completely updated regarding any other process which a third party or company is involved. A notification module suitable for this purpose is illustrated in FIG. 12.

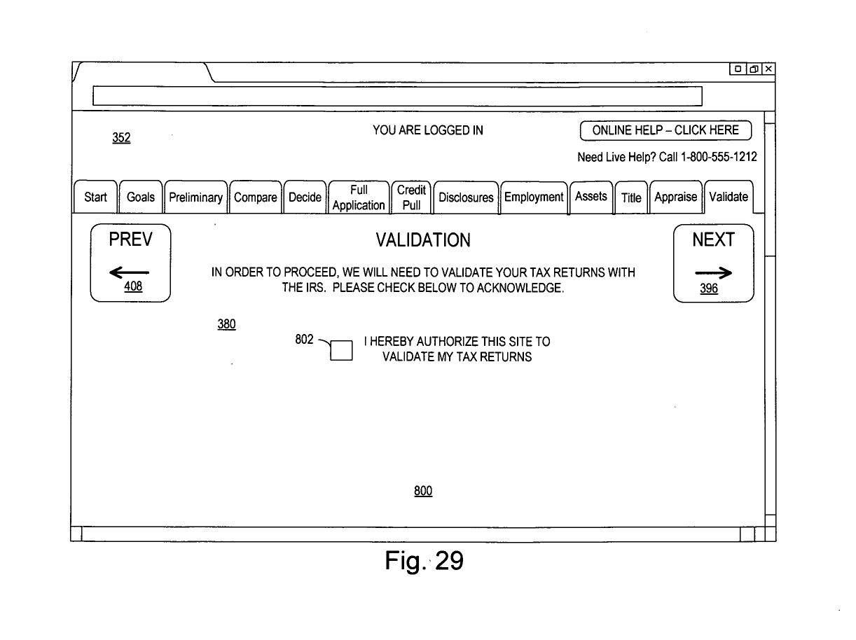

Once an appraisal request is successfully entered, operation continues to validation via Validations Engine 138. One embodiment of a validation interface for Validations Engine 138 is depicted in FIG. 29. The validation interface is provided to enable the user to indicate that they acknowledge their tax returns will be validated with the IRS. In certain embodiments, it may allow for addition of explanations or narratives. In terms of process flow, this acknowledgement may be inserted elsewhere, such as before the title or appraisal ordering portions, depending on the particular embodiment.

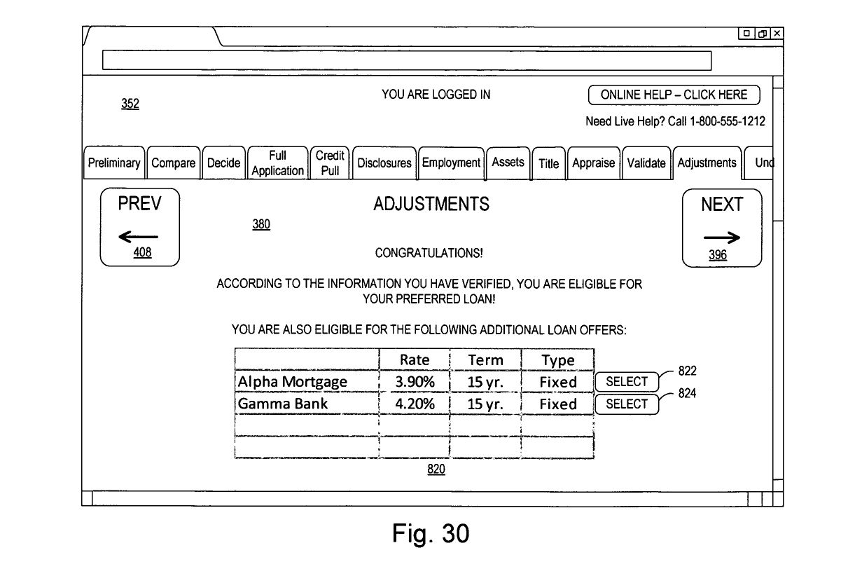

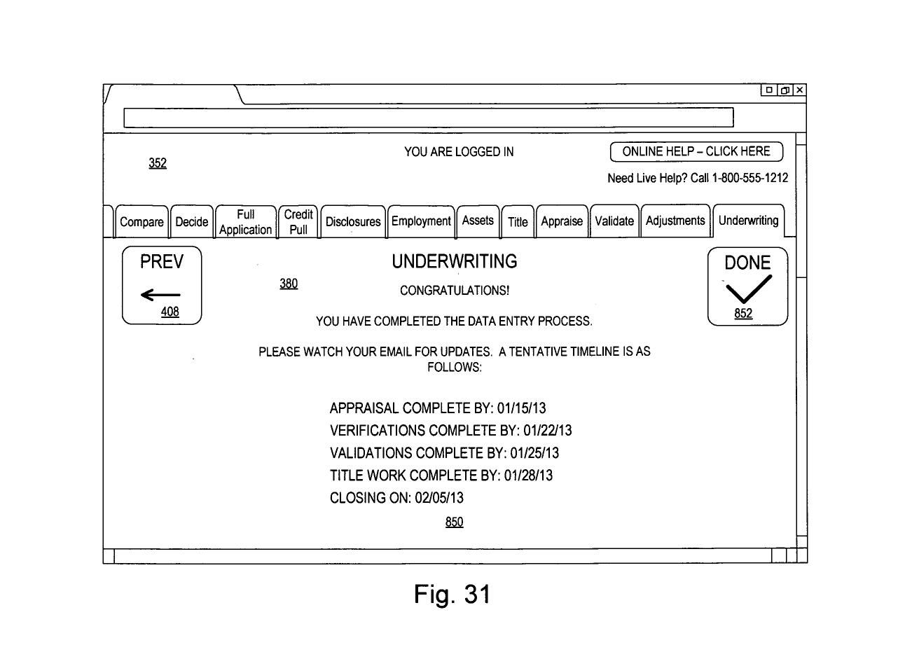

Following validation, operation continues to Pricing Adjustments Engine 206. An embodiment of a pricing adjustments interface for Pricing Adjustments Engine 206 is included as FIG. 30. This interface and module may automatically pull from the Pricing Engine 144 any additional adjustments to rate or closing costs because of changes in information from the initial application to the actual up-to-the-minute information acquired. As an example, if an appraisal comes in lower than expected, a pricing adjustment may be necessary. In certain cases, a user may choose to compare a higher rate with lower fees against a lower rate with additional fees, before submitting their file into underwriting. This module and interface may indicate to the user, based upon the user's initial goals, that there are additional programs that they now qualify for, or that they no longer qualify for one of the initial options. The user enters the preferred option in 208.

After pricing adjustments (if any) are addressed, operation continues to the Submission Engine 210 and then to Underwriting Engine 212. At this point in the process, the user's tasks are complete. One embodiment of an underwriting confirmation page useful in combination with Underwriting Engine 212 is shown in FIG. 31. This page may provide the user with a timeline, based upon their preferred closing, as well as when certain milestones, such as the title work, appraisal, verifications and validations are expected to be completed or returned. Any conflicts in timing may be identified by the system and may result in a prompt to the user to adjust their preferred closing date and times. During the underwriting process, the user may receive, via a notifications module or process such as Notifications Engine 244, automated emails or text messages that allow them to track the progress of the application through the underwriting process.

After underwriting is initiated, operation continues to a determination as to whether the loan is to be approved, suspended or declined via an Approval/Declination Engine 214. Once an application is underwritten and a decision is made, an alert message may be generated to notify the user to log in to the system and review the lender's decision. The user may then be presented with an opportunity to respond to or satisfy any conditions that the lender may have placed on the decision. The user may also be provided with the capabilities to contact the bank for clarification on any such items. Once conditions are cleared by an underwriter, automated underwriting module, or other similar construct, the loan application proceeds to Closing and Funding Engine 216, and corresponding documents are transmitted to the title company for the user's closing. Subsequently, process flow proceeds to Post Closing Engine 218.

According to certain embodiments of the present disclosure, the broad variety of engines, modules and portals comprising the system are operably connected to one another and to a central database. Accordingly, the various modules are able to communicate and coordinate internally without requiring manual intervention or external input. FIG. 4 depicts this relationship schematically, wherein Application Engine 240, Closing/Funding Engine 216, Post Closing Engine 218, Approval/Declination Engine 214, Underwriting Engine 212, Front End 132, Pricing Adjustments Engine 206, FHA/VA Engine 204, Validations Engine 138, Research Engine 248, Regulatory Engine 250, Compilation Engine 252, Purchase Engine 164, Refinance Engine 166, Administration Engine 242, Loan Comparison Engine 182, Property Lookup Engine 180, Credit Questionnaire Engine 188, Credit Inquiry/Import Engine 190, Denial/Partner Engine 194, CRA Engine 148, VOE Engine 196, Notifications Engine 244, Processing Engine 246, Goals Questionnaire Engine 174, Title Engine 146, Asset Engine 198, AUS Engine 136, Pricing Engine 144 and AMC Engine 140 are interconnected with one another, with servers 102 and with databases 104 via network 120. It will be understood by those of skill in the art that other engines, modules and portals may be interconnected within the system. It will also be understood by those of skill in the art that certain embodiments may not incorporate all of the engines, modules and portals shown in FIG. 4, and that certain engines, modules and portals may be combined together in certain implementations.

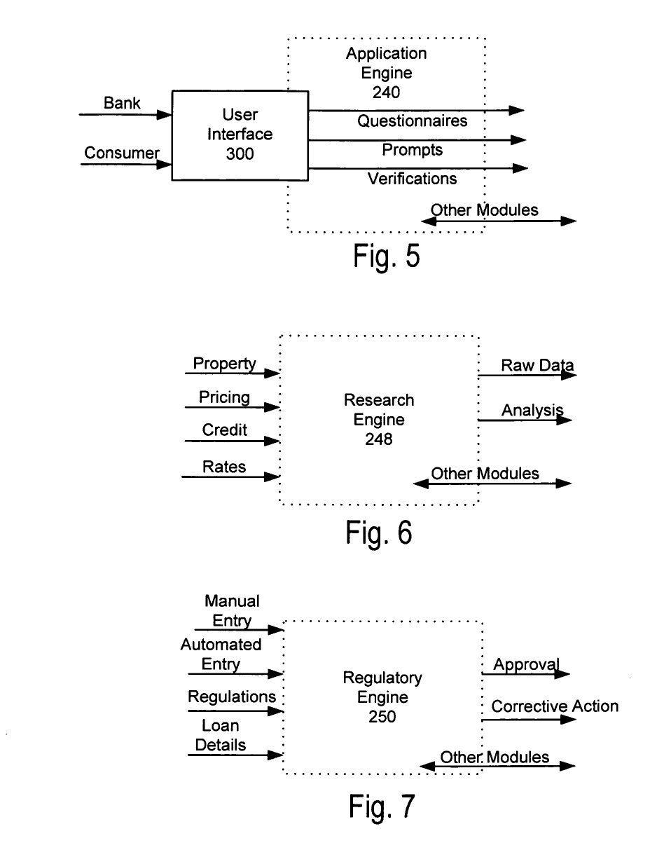

FIG. 5 illustrates numerous aspects of Application Engine 240, which may be provided to manage the application portions of the system. FIG. 5 is a block diagram showing certain aspects of an Application Engine 240 according to the present disclosure. As seen in FIG. 5, Application Engine 240 comprises a user interface operable to receive inputs from one or more banks and one or more consumers, and to provide outputs in the form of questionnaires, prompts and verifications. The User Interface 300 may be provided as part of, or in conjunction with, Application Engine 240. The User Interface 300 may also be operatively coupled to and utilized by other engines, modules and portals as well. Application Engine 240 is further operable to connect and communicate with other modules, portals and processes in the system, including but not limited to the Preliminary Application Engine 176 and Full Application Engine 186.

FIG. 6 is a block diagram showing certain aspects of a Research Engine 248 of the present disclosure. Research Engine 248 may be provided and utilized to collect various application related data, including data on property, pricing, credit and rates, as examples. The output from the Research Engine 248 may be raw data, analysis, or some combination of the two. This module may be operatively coupled to or utilized by any of the modules requiring external data. In certain cases, a particular Research Engine 248 may be optimized to conduct a particular type of research.

FIG. 7 is a block diagram showing certain aspects of a Regulatory Engine 250 according to the present disclosure. Regulatory Engine 250 receives regulatory rules and loan details, both via manual and automatic entry. Regulatory Engine 250 may output an approval of a proposal, a denial, a partial approval or a set of one or more corrective actions. This engine may be operatively coupled to or utilized by any of the modules requiring review for regulatory compliance.

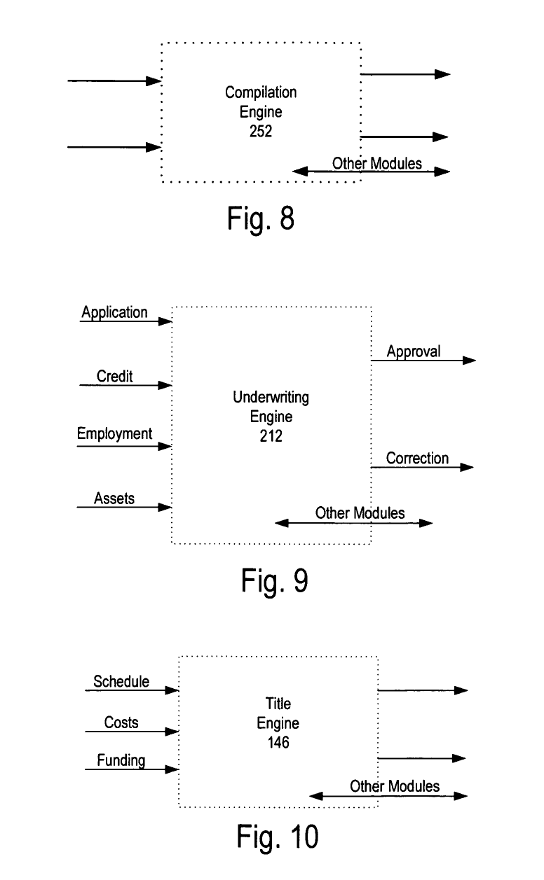

FIG. 8 is a block diagram showing certain aspects of a Compilation Engine 252 according to the present disclosure. Compilation Engine 252 compiles data received and outputs the compiled data to other modules and portals requiring such data. This engine may be operatively coupled to or utilized by any of the engines or other components requiring access to its functions.

FIG. 9 is a block diagram showing certain aspects of an Underwriting Engine 212 according to the present disclosure. Underwriting Engine 212 receives inputs, including application data, credit history, employment and assets, and performs an underwriting analysis. The output from Underwriting Engine 212 may be an approval or a set of corrective actions. This engine may be operatively coupled to or utilized by any of the other engines, modules and portals.

FIG. 10 is a block diagram showing certain aspects of a Title Engine 146 according to the present disclosure. Title Engine 146 receives various inputs including schedule, funding and closing costs. This engine may be operatively coupled to or utilized by any of the engines or other components requiring access to title-related information.

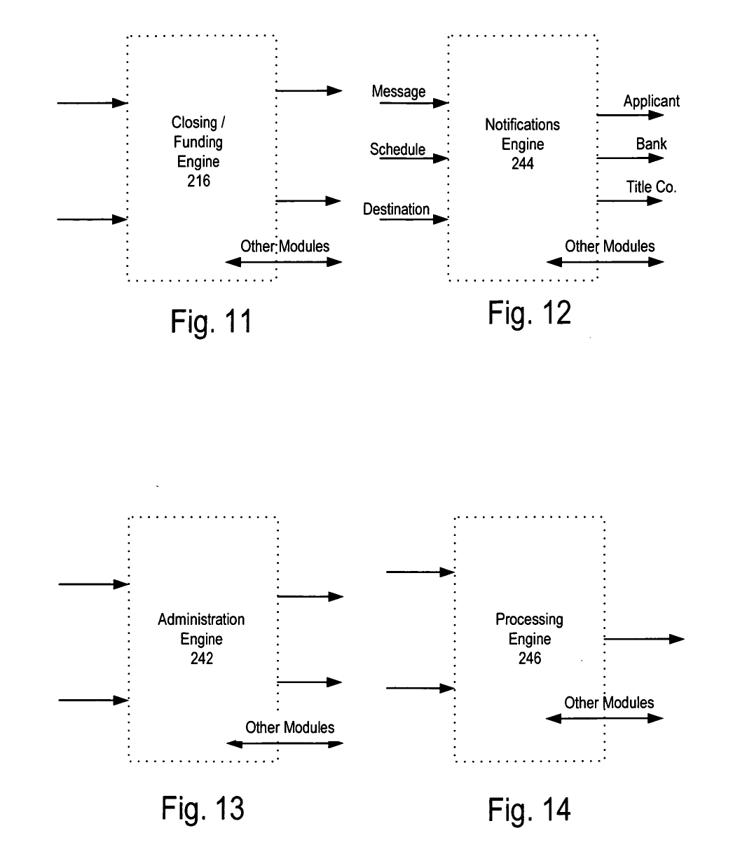

FIG. 11 is a block diagram showing certain aspects of a Closing/Funding Engine 216 according to the present disclosure. This module receives certain inputs related to closing and funding and provides appropriate outputs. This engine may be operatively coupled to or utilized by any of the engines or other components providing or requiring access to closing or funding-related information.

FIG. 12 is a block diagram showing certain aspects of a Notifications Engine 244 according to the present disclosure. Inputs may include messages, destination identifiers and message scheduling. Notifications may be delivered to applicants, banks or title companies. This engine may be operatively coupled to or utilized by any of the engines or other components requiring review for regulatory compliance.

FIG. 13 is a block diagram showing certain aspects of an Administration Engine 242 according to the present disclosure. This engine may be operatively coupled to or utilized by any of the engines or other components requiring access to administration functions.

FIG. 14 is a block diagram showing certain aspects of a Processing Engine 246 according to the present disclosure. This engine may be operatively coupled to or utilized by any of the components requiring access to processing functions.

FIG. 15 is a screen layout of a user interface 350 for Initiation Engine 160 according to the present disclosure. Initiation Engine 160 is described in connection with FIG. 3, above. As shown in this figure, user interface 350 is shown being presented within a web browser window. Those of skill in the art will appreciate that the same functionality may be provided via a stand-alone application. User interface 350 comprises a variety of elements, including a header section 352, a set of navigation tabs 354-378 and a content section 380.

Header section 352 incorporates a set of controls useful on any of the pages of the user interface, including a user id field 382, a login button 384 and a help button 386. This portion of the user interface is persistent from one page to another.

Disposed immediately below the header section, the set of navigation tabs 354-378 comprises start tab 354, goals tab 356, preliminary application tab 358, loan comparison tab 360, decision tab 362, full application tab 364, credit pull tab 366, disclosures tab 368, employment tab 370, assets tab 372, title tab 374, appraisal tab 376 and validation tab 378. Each of navigation tabs 354-378 is operably connected to, and designed to open, the page corresponding to the tab when selected, in order to facilitate efficient navigation within the user interface.

Immediately below navigation tabs 354-378, a content section 380 comprises a page title 388, purchase residence type field 390, refinance residence type field 392, refinance purpose field 394 and ‘next’ button 396. The operation of these entry fields and controls is according to the manner described above in connection with element 160 of FIG. 3.

FIG. 16 is a screen layout of a goals interface page 400 according to the present disclosure. Goals interface page 400 has been briefly described above in connection with FIG. 3. As seen in FIG. 16, the header section 352 remains the same as shown and described above in connection with FIG. 15. The content section 380, however, has been modified from that shown above. In this page, content section 380 contains a set of data entry fields 402-406. These include primary goal entry field 402, secondary entry field 404 and tertiary entry field 406. Depending on the implementation, fields may be simple text entry fields, drop downs, text entry with auto complete, or any combination thereof. This information relates generally to the desirable term of the loan, the balance between closing costs and rates, and the level of risk tolerance on adjustable rates, and this information will be used by the system to identify one or more loans suitable for the user. If the user finds it necessary to revise information on a prior page, the user may use ‘prey’ button 408. When the user has entered the necessary data and is prepared to move forward, the user can press ‘next’ button 396 to proceed.

FIG. 17 is a screen layout of a preliminary application interface page 420 according to the present disclosure. Preliminary application interface page 420 has been briefly described above in connection with FIG. 3. As seen in FIG. 17, the header section 352 remains the same as shown and described above in connection with prior pages. The content section 380, however, is unique to this page. In this page, content section 380 contains a set of data entry fields 422-430. These include equity query 422, down payment query 424, credit score query 426, property address 429 and annual household income query 430. Depending on the implementation, these fields may be simple text entry fields, drop downs, text entry with auto complete, or any combination thereof. This information relates generally to the applicant's ability to carry the requested loan, and this information will be used by the system to make a preliminary determination. If the user finds it necessary to revise information on a prior page, the user may use ‘prey’ button 408. When the user has entered the necessary data and is prepared to move forward, the user can press ‘next’ button 396 to proceed.

FIG. 18 is a flowchart showing a process flow for loan filtering and prioritizing according to the present disclosure. This process was described briefly above in connection with FIG. 3. According to the process shown, the first step, in block 450, is to acquire the applicant's goals. This is done via the goals interface page 400 shown in FIG. 15. Once the applicant's goals are identified, the system acquires a set of available offers in block 452. The available offers are filtered by the applicant's primary goal in block 454. In block 456, a determination is made as to whether any of the available offers comply with the primary goal. If no offers conform to the applicant's primary goal, the applicant is notified in block 458, the goals are revised in block 460 and process flow returns to block 452.

If at least one offer conforms to the applicant's primary goal, process flow proceeds to block 462, where the offers are filtered by the applicant's secondary goal, and process flow proceeds to decision block 464. Process flow from decision block 464 depends on whether there are offers remaining after filtering by the applicant's secondary goal. If there are offers remaining, process flow proceeds to block 466. If there are not offers remaining, process flow proceeds to block 458.

In block 466, the remaining offers are filtered by the applicant's tertiary goal, and process flow proceeds to decision block 468. Process flow from decision block 468 depends on whether there are offers remaining after filtering by the applicant's tertiary goal. If offers remain, process flow proceeds to block 470. If there are no remaining offers, process flow proceeds to block 458.

In block 470, the offers remaining after filtering are presented to the user, and process flow proceeds to decision block 472. Process flow from decision block 472 depends on whether one of the remaining offers is acceptable to the applicant. If no remaining offer is acceptable to the applicant, process flow proceeds to block 458. If at least one remaining offer is acceptable to the applicant, process flow proceeds to block 474, where the user proceeds with the application.

FIG. 19 is a screen layout of a loan comparison interface page 500 according to the present disclosure. Loan comparison interface page 500 has been briefly described above in connection with FIG. 3. As seen in FIG. 19, the header section 352 remains the same as shown and described above in connection with prior pages. The content section 380, however, is unique to this page. In this page, content section 380 contains a table comprising a set of loan data columns 502-508 and a set of selection buttons 510-516. The loan data columns include lender name column 502, rate column 504, term column 506 and loan type column 508. Those of skill in the art will appreciate that alternate embodiments may include more types of information or less. This information relates generally to the loans meeting the applicant's previously-identified goals, and this information will be used by the system to identify which of the available offers is preferred by the applicant. In order to select one of the loan offers as the preferred offer, the user clicks the appropriate one of the loan selection buttons 510-516. If the user finds it necessary to revise information on a prior page, the user may use ‘prey’ button 408. When the user has selected a loan and is prepared to move forward, the user can press ‘next’ button 396 to proceed.

FIG. 20 is a screen layout of an account creation interface page 550 according to the present disclosure. Account creation interface page 550 has been briefly described above in connection with FIG. 3. As seen in FIG. 20, the header section 352 remains the same as shown and described above in connection with prior pages. The content section 380, however, is unique to this page. In this page, content section 380 contains a set of data entry fields 552-558. These include user name query 552, email address query 554, login ID query 556 and password query 558. Depending on the implementation, any of these fields may be simple text entry fields, drop downs, text entry with auto complete, or any combination thereof. This information will be used by the system to authenticate the user on future visits. When the user has entered the necessary data and is prepared to move forward, the ‘next’ button 396 will take the user to the next page.

FIG. 21 is a screen layout of a full application interface page 600 according to the present disclosure. Full application interface page 600 has been briefly described above in connection with FIG. 3. As seen in FIG. 21, the header section 352 remains substantially the same as shown and described above in connection with prior pages, except that the header now reflects that the user has logged in to the system. As above, the content section 380 is unique to this page. In this page, content section 380 contains a set of data entry fields 602-610. These include bankruptcy query 602, judgments query 604, tax liens query 606, discharged query 608 and discharge date query 610. Depending on the implementation, fields may be simple text entry fields, drop downs, text entry with auto complete, or any combination thereof. This information relates generally to the applicant's eligibility for the preferred loan offer, and this information will be used by the system to make that determination. When the user has entered the necessary data and is prepared to move forward, the ‘next’ button 396 will take the user to the next page.

FIG. 22 is a flowchart showing a process of applicant screening according to the present disclosure. The applicant screening process has been briefly described above in connection with FIG. 3. Process flow begins in block 620, wherein the credit questionnaire is presented to the user and information acquired, and the proceeds to decision block 622. Process flow from block 622 depends on whether the user has indicated that there is a bankruptcy, judgment or tax lien on the applicant. If there are such credit issues, process flow proceeds to decision block 624. If no such issues are present, process flow proceeds to decision block 626.

Process flow from decision block 624 depends on whether the identified credit issues have been satisfied or discharged. If the issues have been satisfied or discharged, process flow proceeds to decision block 626. If the issues have not been satisfied or discharged, process flow proceeds to block 628.

Process flow from decision block 626 depends on whether the applicant meets the guidelines for the identified preferred loan. If the applicant does not meet the guidelines, process flow proceeds to block 628. If the applicant does meet the guidelines, process flow proceeds to block 632.

In block 628, the user is alerted that there are indications that the applicant may not meet the guidelines for the identified preferred loan, and advised that a credit pull may negatively affect the applicant's credit rating. Process flow then proceeds to decision block 630.

Process flow from decision block 630 depends on whether the user wishes to proceed with the credit pull. If the user elects to proceed with the credit pull, process flow proceeds to block 632. If the user declines to authorize a credit pull, process flow proceeds to block 636.

In block 632, the applicant's credit report is pulled from one or more credit reporting agencies (CRAs) and process flow proceeds to decision block 634. Process flow from decision block 634 depends on whether the applicant's credit report reflects information establishing that the applicant meets the guidelines for the identified preferred offer. If the applicant does not appear to meet the guidelines, process flow proceeds to block 636. If the applicant appears to meet the guidelines, process flow proceeds to block 638.

In block 636, applicants whose credit history do not meet the loan eligibility criteria are redirected to one or more partner portals able to make additional loan offers having less stringent eligibility criteria. In block 638, applicants having a credit history indicating eligibility for the identified preferred loan proceed with their application within the system.

FIG. 23 is a screen layout of a credit pull interface page 650 according to the present disclosure. Credit pull interface page 650 has been briefly described above in connection with FIG. 3. As seen in FIG. 23, the header section 352 remains the same as shown and described above in connection with prior pages, but the content section 380 is unique to this page. In this page, content section 380 contains a social security number query 652 and an authorization block 654. When the user has entered the necessary data and is prepared to move forward, the ‘next’ will advance to the next page.

FIG. 24 is a screen layout of a disclosures interface page 680 according to the present disclosure. Disclosures interface page 680 has been briefly described above in connection with FIG. 3. In this page, content section 380 contains a disclosure display button 682 and a disclosure acknowledgement block 684. Disclosure display button 682 is operable to display all the necessary disclosures to the user, either on one page or a series of pages. After the user has reviewed and acknowledged the disclosures, pressing the ‘next’ button 396 will advance to the next page.

FIG. 25 is a screen layout of an employment verification interface page 700 according to the present disclosure. Employment verification interface page 700 has been briefly described above in connection with FIG. 3. In this page, content section 380 contains a set of data entry fields 702-708, automated verification flag 710 and multiple employers' button 712. Data entry fields 702-708 include employer name query 702, employer address query 704, employer phone number query 706 and date hired query 708. Depending on the implementation, fields may be simple text entry fields, drop downs, text entry with auto complete, or any combination thereof. When the user has entered the necessary data and is prepared to move forward, the user presses ‘next’ button 396 to proceed.

FIG. 26 is a screen layout of an asset verification interface 720. Asset verification interface 720 has been briefly described above in connection with FIG. 3. In this page, content section 380 contains a set of buttons 722-728. Buttons 722-728 provide various channels through which a user can import bank statements to the system. These include a direct import button 722, electronic statement upload button 724, scanned statement upload button 726 and fax statement button 728. When the user has entered the necessary data and is prepared to move forward, the pressing ‘next’ button 396 moves on to the next page.

FIG. 27 is a screen layout of a title company selection interface 750. Title company selection interface 750 has been briefly described above in connection with FIG. 3. In this page, content section 380 contains a zip code query 752, a list of title companies, a series of selection buttons 754-762 a preferred closing date query 764 and an alternate closing date query 766. Depending on the implementation, the data entry fields may be simple text entry fields, drop downs, text entry with auto complete, or any combination thereof. The zip code query employs a ‘store finder’ algorithm to sort title companies based on proximity to a particular location. The selection buttons 754-762 are used to select one of the title companies from the list. This information is used by the system to select a title company and schedule a closing date. When the user has selected a title company and closing dates and is prepared to move forward, the user presses ‘next’ button 396 to proceed.

FIG. 28 is a screen layout of an appraisal interface 780. Appraisal interface 780 has been briefly described above in connection with FIG. 3. In this page, content section 380 contains a set of data entry fields 782-790. These include credit card number query 782, credit card expiration date query 784, preferred appraisal date query 786, first backup appraisal date 788 and second backup appraisal date 790. Depending on the implementation, fields may be simple text entry fields, drop downs, text entry with auto complete, calendar tools or any combination thereof. This information relates generally to the appraisal process, and this information will be used by the system to automatically schedule an appraisal. When the user has entered the necessary data and is prepared to move forward, pressing ‘next’ button 396 moves forward.

FIG. 29 is a screen layout of a validation interface 800. Validation interface 800 has been briefly described above in connection with FIG. 3. In this page, content section 380 contains a notification of validation and a validation authorization block 802 wherein the user can authorize the validation process. Once the user has authorized validation and is prepared to move forward, pressing ‘next’ button 396 advances the process.

FIG. 30 is a screen layout of an adjustments interface page 820. Adjustments interface page 820 has been briefly described above in connection with FIG. 3. In this page, content section 380 contains a table listing additional loan offers along with a corresponding set of selection buttons 822, 824. If the user decides that one of the listed loan offers is preferable to the earlier-identified preferred offer, the user can select the offer by clicking the selection button 822, 824 adjacent to that offer. The user is not, however, under an obligation to select one of the alternate offers, unless the originally-identified loan offer is no longer available. When the user is prepared to move forward, the user can press ‘next’ button 396 to proceed.

FIG. 31 is a screen layout of an underwriting interface page 850. Underwriting interface page 850 has been briefly described above in connection with FIG. 3. In this page, content section 380 contains a status update message noting that the user has completed the data entry portion of the process, along with a timeline identifying the dates by which certain underwriting and closing milestones are expected to be completed. If the user finds it necessary to revise information on a prior page, the user may use ‘prey’ button 408. Otherwise, the user presses ‘done’ button 852 when the user's data entry obligations are completed.

Although the process and system has been described above in connection with certain illustrative embodiments, those of skill in the art will appreciate that the above-described embodiments are only provided by way of example. As an example, in certain embodiments, a user may, at any point in time, be given the ability to submit their file for a manual underwrite. This may be particularly desirable if the system is rejecting their information or indicating numerous problems. The user may also be given the ability to communicate with a help desk to troubleshoot any questions or problems they are having, or a number of automated videos and audio tutorials may be provided in each section.

The entire system of the present disclosure may be pre-formatted in any language, or may provide user-selectable language toggles. Similarly, the entire system may be adapted to interface with disparate bank systems, or customized for use in a particular end-use. Similar embellishments, and various combinations thereof, are all comprehended by the present disclosure. All embodiments described herein are presented for purposes of illustration and explanation only. The specific compositions, configurations, orientations and operations of various features, portions and members may be provided in a number of ways in accordance with the present disclosure.

Therefore, the embodiments and examples set forth herein are presented to best explain the present disclosure and its practical application and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the present disclosure.

What is claimed is:

1. A mortgage processing system comprising:
structure adapted to acquire applicant goals;
structure adapted to acquire mortgage offers;
structure adapted to compare mortgage offers to applicant goals;
structure adapted to identify one or more mortgage offers for presentation to the applicant;
structure adapted to present the identified mortgage offers to the applicant; and
structure adapted to acquire an identification of a preferred mortgage offer.

2. The system of claim 1, wherein the structures are disposed on one or more servers operably connected to the internet.

3. The system of claim 1, further comprising structure adapted to acquire background information from the applicant via the internet.

4. The system of claim 1, further comprising structure adapted to acquire background information from third-party sources via the internet.

5. The system of claim 4, wherein the background information includes the applicant's credit history.

6. The system of claim 4, wherein the background information includes the applicant's employment information.

7. The system of claim 1, comprising structure adapted to compare a set of mortgage eligibility guidelines to a collection of acquired data.

8. The system of claim 6, further comprising structure adapted to determine whether the collection of acquired data indicates that the applicant is eligible for the mortgage under the mortgage eligibility guidelines.

9. The system of claim 4, wherein the background information from third-party sources comprises regulatory information.

10. The system of claim 9, wherein the background information from third-party sources comprises regulatory information from federal sources.

11. The system of claim 9, wherein the background information from third-party sources comprises regulatory information from state sources.

12. The system of claim 4, wherein the background information from third-party sources comprises applicant credit information.

13. The system of claim 4, wherein the background information from third-party sources comprises mortgage program information.

14. The system of claim 1, further comprising structure adapted to modify the identified mortgage offers responsive to background information obtained from third-party sources.

15. The system of claim 1, further comprising structure adapted to modify the identified mortgage offers responsive to background information obtained from the applicant.

16. A loan processing system comprising:
structure adapted to acquire applicant goals;
structure adapted to acquire loan offers;
structure adapted to compare loan offers to applicant goals;
structure adapted to identify one or more loan offers for presentation to the applicant;
structure adapted to present the identified loan offers to the applicant; and
structure adapted to acquire an identification of a preferred loan offer.

17. The system of claim 16, wherein the structures are disposed on one or more servers operably connected to the internet.

18. The system of claim 16, further comprising structure adapted to acquire background information from the applicant via the internet.

19. The system of claim 16, further comprising structure adapted to acquire background information from third-party sources via the internet.

20. The system of claim 19, wherein the background information includes the applicant's credit history.

21. The system of claim 19, wherein the background information includes the applicant's employment information.

22. The system of claim 16, comprising structure adapted to compare a set of loan eligibility guidelines to a collection of acquired data.

23. The system of claim 22, further comprising structure adapted to determine whether the collection of acquired data indicates that the applicant is eligible for the loan under the loan eligibility guidelines.

24. The system of claim 19, wherein the background information from third-party sources comprises regulatory information.

25. The system of claim 19, wherein the background information from third-party sources comprises applicant credit information.

26. The system of claim 4, wherein the background information from third-party sources comprises loan program information.

27. The system of claim 16, further comprising structure adapted to modify the identified loan offers responsive to background information obtained from third-party sources.

28. The system of claim 16, further comprising structure adapted to modify the identified loan offers responsive to background information obtained from the applicant.
